(19) United States
(12) Patent Application Publication
(10) Pub. No.: US 2026/0080658 A1
(43) Pub. Date: Mar. 19, 2026

(54) DATA AUGMENTATION DEVICE AND METHOD FOR BACKGROUND BIAS REMOVING IN CASE OF WEAKLY SUPERVISED SEMANTIC SEGMENTATION

(71) Applicant: CHUNG ANG UNIVERSITY INDUSTRY ACADEMIC COOPERATION FOUNDATION, Seoul (KR)

(72) Inventors: YOUNG BIN KIM, Seoul (KR); JUNE HYOUNG KWON, Seoul (KR)

(21) Appl. No.: 19/327,178

(22) Filed: Sep. 12, 2025

(30) Foreign Application Priority Data
Sep. 13, 2024 (KR) 10-2024-0125769

(51) Int. Cl. G06V 10/26; G06T 7/174; G06T 7/194; G06T 11/00; G06V 10/764; G06V 10/774

(52) U.S. Cl. CPC G06V 10/273; G06T 7/174; G06T 7/194; G06T 11/00; G06V 10/764; G06V 10/774; G06T 2207/20081

(57) ABSTRACT

A data augmentation method includes inputting multiple images constituting a mini-batch into an encoder and extracting features for respective images of the multiple images, inputting the extracted features of the respective images into a pre-trained first aggregator and second aggregator and separating the extracted features into object features, each being a feature of an object portion of each image, and background features, each being a feature of a background portion of each image, inputting the object feature and background feature of each of the images into a shuffler and shuffling either the object features or the background features within the mini-batch, generating a synthetic feature by synthesizing the shuffled feature and a non-shuffled feature among the object feature and the background feature in a synthesis unit, and generating a data-augmented image based on the synthetic feature.

### CROSS-REFERENCE TO RELATED APPLICATION AND CLAIM OF PRIORITY

This application claims the benefit under 35 USC § 119 of Korean Patent Application No. 10-2024-0125769, filed on Sep. 13, 2024, in the Korean Intellectual Property Office, the entire disclosure of which is incorporated herein by reference for all purposes.

### BACKGROUND

### 1. Field

The present disclosure relates to a data augmentation device and method for background bias removing in case of weakly supervised semantic segmentation.

### 2. Description of Related Art

Semantic segmentation is a task of classifying which class each pixel in an image belongs to. Since acquiring pixel-level labels for semantic segmentation is expensive and time-consuming, weakly supervised semantic segmentation (WSSS) is being actively studied to alleviate this problem. Weakly supervised semantic segmentation (WSSS) uses weak labels that contain less information about an object's location than pixel-level labels, but are cheaper to annotate.

When utilizing image-level class labels in weakly supervised semantic segmentation (WSSS), a class activation map (CAM) is used as an initial seed for estimating a region occupied by the object. Classifiers are trained to predict a category (class) of an image and identify a target object region. However, classifiers often overemphasize background regions to generate blurred CAMs. This is because classifiers exploit biases in a dataset as a shortcut rather than making predictions using information related to the object. This background bias stems from biased datasets consisting of images in which specific objects frequently appear alongside specific background contexts.

In addition, since the context or background in which an object appears is not considered in the past, there is a problem in that deep learning models trained with augmented data are affected by the background bias where specific objects and backgrounds frequently appear together, and thus the accuracy at the pixel-level labels is limited.

FIG. 1 is a diagram illustrating an existing semantic segmentation method using a short-cut. Referring to FIG. 1, the existing semantic segmentation method had a problem of roughly using the “sky” region (especially the flight path part) that appears alongside the “airplane” as a shortcut, thereby generating an inaccurate class activation map (CAM) and an incorrect pseudo-mask.

Examples of related art may include Korean Unexamined Patent Application Publication Nos. 10-2022-0115757 and 10-2023-0035297.

### SUMMARY

Embodiments of the present disclosure are intended to provide a data augmentation device and method capable of alleviating background bias during weakly supervised semantic segmentation.

According to an aspect of the present disclosure, there is provided a data augmentation method performed on a computing device that includes one or more processors and a memory storing one or more programs executed by the one or more processors, the method including inputting multiple images constituting a mini-batch into an encoder and extracting features for respective images of the multiple images, inputting the extracted features of the respective images into a pre-trained first aggregator and second aggregator and separating the extracted features into object features, each being a feature of an object portion of each image, and background features, each being a feature of a background portion of each image, inputting the object feature and background feature of each of the images into a shuffler and shuffling either the object features or the background features within the mini-batch, generating a synthetic feature by synthesizing the shuffled feature and a non-shuffled feature among the object feature and the background feature in a synthesis unit, and generating a data-augmented image based on the synthetic feature.

The data augmentation method may further include training the first aggregator and the second aggregator, and the training may include inputting an image to an encoder to extract features for the image, inputting the features for the image to the first aggregator to aggregate object features from the features for the image and inputting the features for the image to the second aggregator to aggregate background features from the features for the image, and performing contrastive learning on the first aggregator and the second aggregator so that a similarity between the object feature and the background feature is reduced.

The shuffling may include shuffling the background features within the mini-batch, and in the generating of the synthetic feature, the synthetic feature may be generated by synthesizing the shuffled background feature with the object feature.

The shuffling may include shuffling the object features within the mini-batch, and in the generating of the synthetic feature, the synthetic feature may be generated by synthesizing the shuffled object feature with the background feature.

The data augmentation method may further include measuring an activation value for object inference for each pixel in the data-augmented image and calculating a degree of background bias in the data-augmented image based on the measured activation value.

The calculating of the degree of background bias may include measuring each of a contribution rate of the object portion and a contribution rate of the background portion in the data-augmented image and calculating the degree of background bias based on a ratio of the contribution rate of the object portion and the contribution rate of the background portion.

The contribution rate of the object portion and the contribution rate of the background portion may be measured by an integrated gradient of each pixel in the data-augmented image.

The integrated gradient of the pixel may be calculated by Equation 4.

$$I ( {x}_{i} ) = ( {x}_{i} - {x}_{base} ) \cdot {\sum }_{k = 1}^{m} \frac{\partial f ( {x}_{base} + \frac{k}{m} ( {x}_{i} - {x}_{base} ) )}{\partial {x}_{i}} \cdot \frac{1}{m} \qquad [ Equation 4 ]$$

$$I ( {x}_{i} ) : integrated gradient of i - th pixel in data - augmented image$$

$${x}_{i} : data - augmented image$$

$${x}_{base} : preset black image$$

$$m : number of gradients$$

$$k : k - th gradient$$

$$\frac{\partial f ( \cdot )}{\partial {x}_{i}} : degree to which i - th pixel in augmented image contributes to classifier ’ s output class score$$

The data augmentation method may further include calculating an activation ratio value by a ratio of an integrated gradient of pixels in an object region and an integrated gradient of pixels in a background region in the data-augmented image.

According to another aspect of the present disclosure, there is provided a computing device that includes a processor and a memory storing one or more programs executed by the processor, the processor is configured to perform an operation of inputting multiple images constituting a mini-batch into an encoder and extracting features for respective images of the multiple images, an operation of inputting the extracted features of the respective images into a pre-trained first aggregator and second aggregator and separating the extracted features into object features, each being a feature of an object portion of each image, and background features, each being a feature of a background portion of each image, an operation of inputting the object feature and background feature of each of the images into a shuffler and shuffling either the object features or the background features within the mini-batch, an operation of generating a synthetic feature by synthesizing the shuffled feature and a non-shuffled feature among the object feature and the background feature in a synthesis unit, and an operation of generating a data-augmented image based on the synthetic feature.

### BRIEF DESCRIPTION OF THE DRAWINGS

FIG. 1 is a diagram illustrating an existing semantic segmentation method utilizing a short-cut.

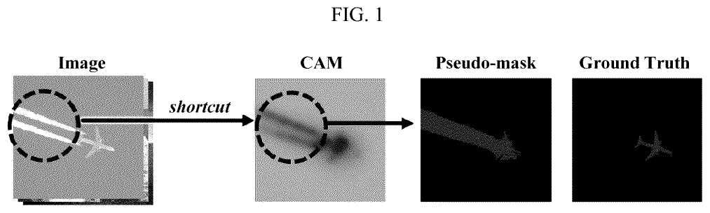

FIG. 2 is a diagram illustrating a process of separating features of an object and a background according to an embodiment of the present disclosure.

FIG. 3 is a diagram illustrating a data augmentation process for randomly combining objects and backgrounds according to an embodiment of the present disclosure.

FIG. 4 is a diagram illustrating a configuration of a data augmentation device for removing background bias in case of weakly supervised semantic segmentation according to an embodiment of the present disclosure.

FIG. 5 is a flowchart of a data augmentation method for removing background bias in case of weakly supervised semantic segmentation.

FIG. 6 is a photograph comparing pixel-level labels generated using a weakly supervised semantic segmentation method.

FIG. 7 is a photograph comparing category activation map visualizations using a data augmentation method according to an embodiment of the present disclosure.

FIG. 8 is a block diagram for illustratively describing a computing environment including a computing device suitable for use in exemplary embodiments.

### DETAILED DESCRIPTION

Hereinafter, specific embodiments of the present disclosure will be described with reference to the drawings. The following detailed description is provided to facilitate a comprehensive understanding of the methods, apparatuses, and/or systems described herein. However, this is only an example and the present disclosure is not limited thereto.

In describing embodiments of the present disclosure, if it is determined that a specific description of a related known function of the preset invention may unnecessarily obscure the gist of the present disclosure, the detailed description thereof will be omitted. The terms described below are terms defined in consideration of the functions in the present disclosure, and vary depending on the intention or custom of the user or operator. Therefore, the definition should be made based on the contents throughout this specification. The terminology used in the detailed description is for the purpose of describing embodiments of the present disclosure only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

Before describing the present disclosure, a brief description of semantic segmentation is a process of dividing a digital image into several pixel sets, and simplifying and transforming the representation of the image into an easily interpretable form through semantic segmentation. The semantic segmentation is widely used in the field of computer vision along with object detection.

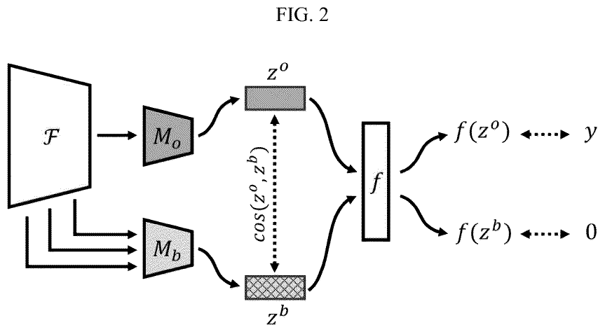

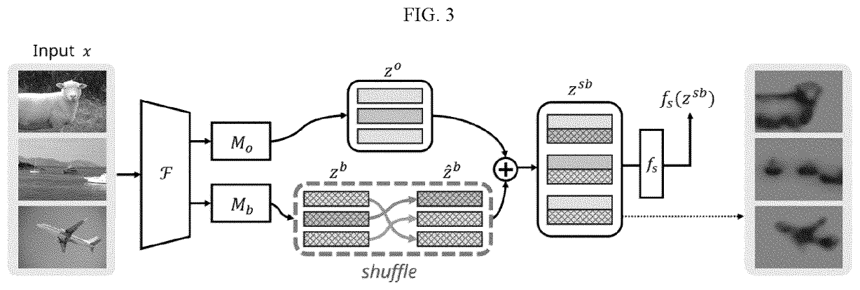

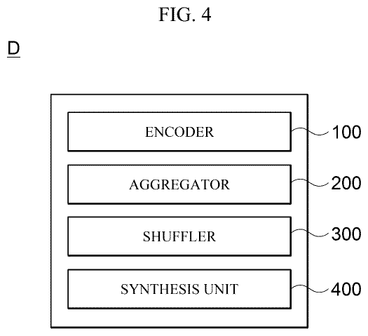

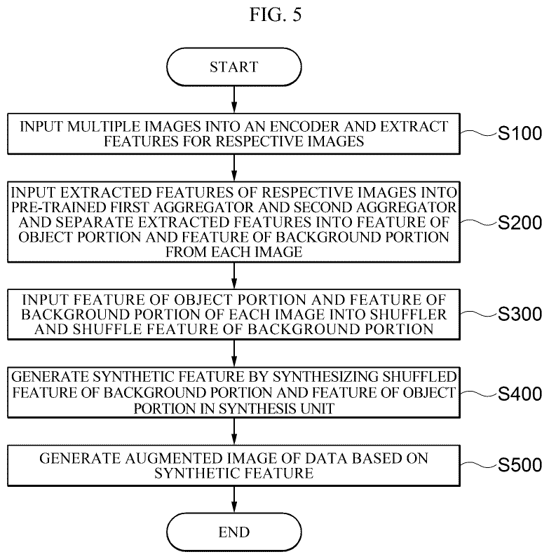

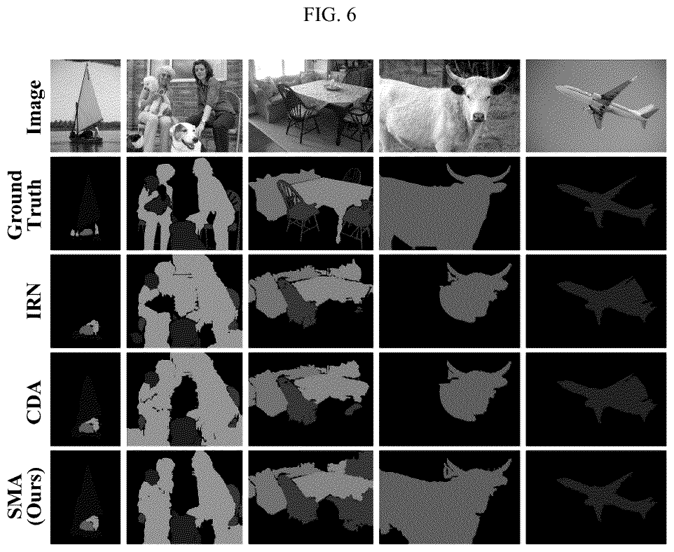

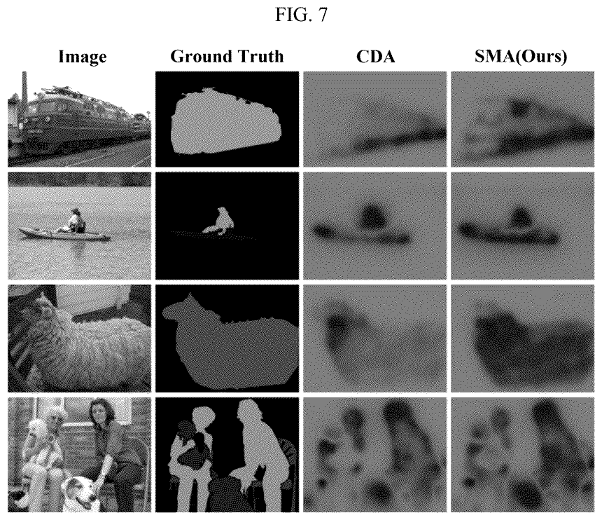

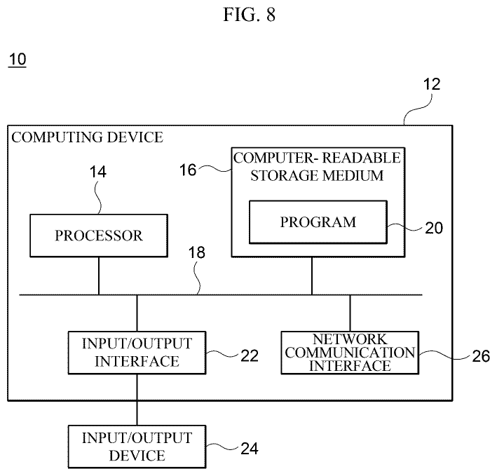

FIG. 2 is a diagram illustrating a process of separating features of an object and a background according to an embodiment of the present disclosure, FIG. 3 is a diagram illustrating a data augmentation process for randomly combining objects and backgrounds according to an embodiment of the present disclosure, FIG. 4 is a diagram illustrating a configuration of a data augmentation device for removing background bias in case of weakly supervised semantic segmentation according to an embodiment of the present disclosure, FIG. 5 is a flowchart of a data augmentation method for removing background bias in case of weakly supervised semantic segmentation, FIG. 6 is a photograph comparing pixel-level labels generated using a weakly supervised semantic segmentation method, FIG. 7 is a photograph comparing category activation map visualizations using a data augmentation method according to an embodiment of the present disclosure, and FIG. 8 is a block diagram for illustratively describing a computing environment including a computing device suitable for use in exemplary embodiments.

First, referring to FIG. 2, a process of training to separate features of an object portion and a background portion in an input image from each other will be described.

As illustrated in FIG. 2, F is an encoder and two aggregators are formed. Mo is a first aggregator and Mb is a second aggregator, and the first aggregator Mo may acquire an object feature z^{o} from features extracted from the encoder F. The second aggregator Mb may acquire a background feature z^{b} from the features extracted from the encoder F. That is, when an image is input to the encoder F, a background zb and an object zo of the image are separated through the first aggregator Mo and the second aggregator Mb.

Next, the image divided into the background and the object goes through a process of differentiation through contrastive learning. Contrastive learning is to distance the object feature z^{o} and the background feature z^{b} from each other so that they do not become similar to each other. To this end, the COS (z^{o}, z^{b}) similarity between the object feature z^{o} and the background feature z^{b} is calculated. That is, the cosine (COS) similarity between the object feature z^{o} and the background feature z^{b} is reduced through contrastive learning.

Next, the object feature z^{o} and the background feature z^{b} may be input to a classifier f, and the classifier f may output classification scores f(z^{o}) and f(z^{b}) for the object feature z^{o} and background feature z^{b}. The classification scores f(z^{o}) and f(z^{b}) output from the classifier f may be compared with labels y and 0, respectively (for convenience, the correct value for the background portion is set to 0).

The classification scores f(z^{o}) and f(z^{b}) output from the classifier f are compared with labels y and 0, respectively, to check whether the background and object are properly separated. A contrastive loss may be additionally used to further distinguish the object feature z^{o} and the background feature z^{b}. Here, the object feature z^{o} and the background feature z^{b} may be mutually exclusive.

The object feature z^{o} is highly relevant to class label prediction, whereas the background feature z^{b} is correlated with the object but is not required to predict class labels. That is, when an image is represented as x, it is assumed that the prediction will not be affected even if the background feature z^{b} is replaced with another feature z^{b}*.

Therefore, an optimal classifier f* should provide consistent predictions without being affected by a background bias. This hypothesis can be expressed as [Equation 1] below.

$$f * ( [ {𝓏}^{o} , {𝓏}^{b} ] ) = f * ( [ {𝓏}^{o} , {𝓏}^{b *} ] ) \qquad [ Equation 1 ]$$

[. , .] represents channel-wise concatenation. That is, shuffling separate representations (Hereinafter, the term “representation” may be used interchangeably with “feature.” That is, “representation” may refer to a feature in the latent space) is used to achieve these consistent predictions.

First, \hat{z}^{b} is obtained by randomly permuting the separated background representation (background feature). Then, \hat{z}^{b} is concatenated to an object representation z^{o} to create a new representation z^{sb}. z^{sb} represents a fixed object-related representation combined with a swapped background representation from another image in a mini-batch (a small data sample randomly selected from the entire data set).

Furthermore, the augmentation action may be performed in the opposite direction to provide more diverse representations to the classifier f. That is, the object representation z° is randomly shuffled to obtain [symbol] , which is then concatenated with the background representation z^{b} to generate z^{so}=[ [symbol] , zb]. Then, Z^{sb} is fed to a classifier fₛ, which supervises a classification score using a target label y. In the case of z^{so}, since objects are shuffled within the mini-batch, the target label y is also rearranged as y\hat{ } according to a permuted index. An objective function for training an augmented classifier using shuffled representations may be expressed as Equation 2.

$${L}_{shuffle} = BCE ( {f}_{s} ( {𝓏}^{sb} ) , y ) + BCE ( {f}_{s} ( {𝓏}^{so} ) , \hat{y} ) \qquad [ Equation 2 ]$$

Therefore, the total loss function may be described by Equation 3 below, where λ represents a balanced scalar.

$$L = {L}_{cls} + λ {L}_{contr} + {L}_{shuffle} \qquad [ Equation 3 ]$$

$${L}_{cls} : Loss function for classification$$

$${L}_{contr} : Contrastive loss function$$

FIG. 3 is a diagram illustrating a data augmentation process for randomly combining objects and backgrounds according to an embodiment of the present disclosure.

In the neural network trained through the sequence shown in FIG. 2 above, images are input (Input x) to the encoder F and the object representation zo and the background representation zb are separated through the first aggregator Mo and the second aggregator Mb.

Next, shuffling is performed on the background representation z^{b} to obtain \hat{z}^{b}. Next, z^{o} and \hat{z}^{b} are concatenated to synthesize a new representation z^{sb}, which is then input to the classifier fₛ. Then, the classifier fₛ outputs a predicted value fₛ(z^{sb}).

Two-way shuffling combines object-related attributes with background attributes that less frequently appear with the corresponding class in the representation space. As a result, the classifier fₛ learns representations that rarely appear in a biased dataset, enabling improved representations of the background and objects in the image with less reliance on shortcut functions. Here, the short-cut function means conveying information by omitting the middle part.

For example, when using an image of an aeroplane with a sky and an image of cows and sheep appearing in a grassy landscape as input, the classifier may learn representations corresponding to “aeroplane with a grassy landscape” and “cows and sheep appearing in the sky” in the representation space using shortcut functions. However, images of these scenes do not exist in a training dataset. Furthermore, the diversity of representations is guaranteed because representations within the mini-batch are randomly combined at each iteration.

Hereinafter, a process for performing a data augmentation method according to an embodiment of the present disclosure will be described with reference to FIGS. 4 and 5.

According to an embodiment, a data augmentation device D is composed of an encoder 100 that receives multiple images and extracts features for respective images of the multiple images, an aggregator 200 composed of a first aggregator Mo and a second aggregator Mb that receive the features of images extracted from the encoder and separates the feature of an object portion and the feature of a background portion from each image, respectively, a shuffler 300 that receives the feature of the object portion and the feature of the background portion of each image from the first aggregator Mo and the second aggregator Mb, respectively, and shuffles the feature of the background portion, and a synthesis unit 400 that generating a synthetic feature by synthesizing the feature of the background portion shuffled by the shuffler 300 and the feature of the object portion.

In the data augmentation device D, multiple images are input to the encoder 100 and features for respective images of the multiple images are extracted (S 100). For reference, a detailed description of the encoder 100 is a conventional encoder (an encoder that extracts features from an images) having widely known functions and configurations, and a detailed description thereof will be omitted as it is far beyond the purpose of the present disclosure.

Next, in the data augmentation device D, the features extracted from the encoder 100 are input to the aggregator 200. The aggregator 200 is composed of a pair of the first aggregator Mo and the second aggregator Mb, and the first aggregator Mo aggregates object features, and the second aggregator Mb aggregates background features (S 200).

Here, the first aggregator Mo and the second aggregator Mb are trained using different labels, and a contrastive learning method may be used to separate the object features and the background features.

Next, in the data augmentation unit D, the object feature and background feature of each image are input to the shuffler 300. The shuffler 300 may generate new background features (new background features generated by randomly changing the order) by shuffling the background features within the mini-batch. Furthermore, the shuffler 300 may generate new object features by shuffling the object features within the mini-match (S 300).

That is, in FIG. 3, an example of generating a new background feature by shuffling a background feature z^{b} in the mini-batch in the shuffler 300 is shown, but it is not limited thereto, and a new object feature [symbol] may be generated by shuffling an object feature z^{o} in the a mini-batch in the shuffler 300. In this way, data augmentation may be performed by shuffling the background features and the object features within the mini-batch.

Next, the synthesis unit 400 may generate a synthetic feature z^{sb} by synthesizing the shuffled object feature and the background feature from the shuffler 300 (S400). For example, the synthesis unit 400 may generate a synthetic feature by synthesizing an object feature with a randomly shuffled background feature. Furthermore, the synthesis unit 400 may generate the synthetic feature by synthesizing a background feature with a randomly shuffled object feature.

Next, in the data augmentation device D, an augmented image of the data is generated based on the synthetic feature (S 500). For example, the synthetic feature may be input to a decoder to generate an augmented image, but is not limited thereto, and various other image generation or restoration techniques may also be used.

The data augmentation method may further include training the first aggregator Mo and the second aggregator Mb. In the training, an image is input to then encoder 100 to extract features for the image, the features for the image are input to the first aggregator to aggregate features of the object portion from the features for the image, the features for the image are input to the second aggregator Mb to aggregate features of the background portion from the features for the image, and contrastive learning is performed so that the similarity between the aggregated features for the object portion and the aggregated features for the background portion is reduced.

The data augmentation method may further include measuring an activation value for object inference for each pixel in the augmented image of the data, and calculating a degree of background bias in the data-augmented image based on the measured activation value.

The degree of background bias may be calculated by measuring a contribution rate of the object portion and a contribution rate of the background portion in the data augmented image, respectively, and calculating the degree of background bias based on a ratio of the contribution rate of the object portion and the contribution rate of the background portion.

The measurement of the contribution rate of the object portion and the contribution rate of the background portion may be performed by measuring an integrated gradient (IG) of each pixel in the data augmented image, and the integrated gradient of each pixel may be calculated Equation 4 below.

$$I ( {x}_{i} ) = ( {x}_{i} - {x}_{base} ) \cdot {\sum }_{k = 1}^{m} \frac{\partial f ( {x}_{base} + \frac{k}{m} ( {x}_{i} - {x}_{base} ) )}{\partial {x}_{i}} \cdot \frac{1}{m} \qquad [ Equation 4 ]$$

$$I ( {x}_{i} ) : integrated gradient of i - th pixel in data - augmented image$$

$${x}_{i} : data - augmented image$$

$${x}_{base} : preset black image$$

$$m : number of gradients$$

$$k : k - th gradient$$

$$\frac{\partial f ( \cdot )}{\partial {x}_{i}} : degree to which i - th pixel in augmented image contributes to classifier ’ s output class score ( gradient )$$

Here, the black image x_{base} is an image having the same resolution as the data-augmented image, and may be an image with no information, for example, an image in which all pixel values are 0. Furthermore, m may mean the number of steps used in the integral approximation. In other words, a straight line path from a baseline (black image) to the input (data-augmented image) is divided into m steps, the gradient at each point is calculated, and the average is taken.

Meanwhile, an activation ratio value of the image is defined as the ratio of the IG of a background region Rb to the IG of an object region Ro. The activation ratio value indicates how much information in the object region is utilized compared to the background region. The activation ratio value may be represented by a short usage ratio (SUR). If the SUR is expressed as an equation, it is shown in Equation 5 below.

$$S U R ( x ) = \frac{{\sum }_{i ∈ {R}_{o}} I ( {x}_{i} )}{{\sum }_{i ∈ {R}_{b}} I ( {x}_{i} )} \qquad [ Equation 5 ]$$

$${R}_{o} : set of pixels in object region$$

$${R}_{b} : set of pixels in background region$$

$$I ( {x}_{i} ) : integrated gradient of i - th pixel in data - augmented image x$$

This activation ratio value may be used as an indicator to measure the extent to which the classifier uses shortcuts.

Furthermore, the data augmentation method may further include a process of calculating a background attribution ratio (BAR) to directly evaluate the extent to which the use of shortcuts has been alleviated. The background attribution ratio (BAR) may be expressed as a ratio between the contribution rate in the background region and the sum of the total contributions when predicting the target class. This background attribution ratio (BAR) may be expressed as Equation 6 below.

$$B A R ( x ) = \frac{{\sum }_{i ∈ {R}_{o}} I ( {x}_{i} )}{{\sum }_{i ∈ ( {R}_{o} ⋃ {R}_{b} )} I ( {x}_{i} )} \qquad [ Equation 6 ]$$

Short-cuts refer to an unintended decision-making decision rule in the prediction process, and in the present disclosure, the background in the image plays this role. Therefore, the extent to which short-cuts are used when predicting class labels may be measured by 1) object-related attributes and 2) background attributes, which can be evaluated using the SUR and the BAR, respectively.

The weakly supervised semantic segmentation model obtained through the data augmentation method composed of the respective steps (S100 to S500) described above may be evaluated using an evaluation index of mIoU (mean Intersection over Union). To verify the performance of the generated category activation map and pixel-level labels, a comparative experiment was conducted between the existing weakly supervised semantic segmentation methodology and the present disclosure on the PASCAL VOC 2012 dataset.

Briefly describing the evaluation index of mIoU (mean Intersection over Union) used in the present disclosure, the mIoU refers to the average value for the IoU value. In an evaluation method for the semantic segmentation model, the IoU (Intersection over Union) for each class is calculated and then the mIoU, which calculates the average for the class, is used, and the IoU has the characteristic of being calculated as an expression of true positive/(true positive+false positive+false negative.

During the evaluation experiment, mean intersection over union (mIoU) was evaluated by performing data augmentation using the data augmentation method of the present disclosure on existing weakly supervised semantic segmentation methods.

As a result of the experiment, it can be confirmed that the augmentation method of the present disclosure demonstrated improved performance compared to previous studies.

TABLE 1
Performance comparison of mIou for category activation
maps and pixel-level labels compared to existing weakly
supervised semantic segmentation methods.

| Method | Seed | Mask |
|---|---|---|
| PSA [2]_{CVPR′18} + SMA (Ours) | 48.0 | 61.0 |
| | 51.4 | 64.1 |
| IRN [1]_{CVPR′19} + SMA (Ours) | 48.3 | 66.3 |
| | 52.4 | 68.6 |
| AdvCAM [22]_{CVPR′21} + SMA (Ours) | 55.6 | 69.9 |
| | 57.8 | 70.4 |
| AMN [25]_{CVPR′22} + SMA (Ours) | 62.1 | 72.2 |
| | 64.4 | 72.7 |

Separately from [Table 1] above, a deep learning-based semantic segmentation model was trained using pixel-level labels generated by applying the proposed data augmentation method to existing weakly supervised semantic methods.

TABLE 2
Performance evaluation of a semantic segmentation
model based on generated pixel-level labels

| Method | val | test |
|---|---|---|
| PSA [2]_{CVPR′18} + SMA (Ours) | 61.7 | 63.7 |
| | 65.9 | 66.8 |
| IRN [1]_{CVPR′19} + SMA (Ours) | 63.5 | 64.8 |
| | 68.6 | 68.7 |
| AMN [25]_{CVPR′22} + SMA (Ours) | 69.5 | 69.6 |
| | 70.9 | 70.8 |

As shown in Table 2 above, as a result of the experiment, it was confirmed that when the method according to the embodiment of the present invention is applied, the semantic segmentation accuracy is improved, and thus a higher level pixel-level labels are generated compared to the existing method.

Below, in order to visually check the pixel-level labels generated through the data augmentation method according to an embodiment of the present disclosure, a qualitative evaluation was performed compared to the existing method.

Referring to FIG. 6, it can be confirmed that in the case of the pixel-level labels generated using the existing weakly semantic method, background regions are captured as objects or only portions of objects are captured, whereas labels for object regions are effectively generated in the image (SMA Ours in FIG. 6) generated using the data augmentation method according to an embodiment of the present disclosure while being relatively less affected by the background.

Referring to FIG. 7, a qualitative comparison was performed on category activation maps generated using data augmentation methods applicable to the weakly supervised semantic segmentation method.

As a result of the experiment, it can be confirmed that object regions are more accurately captured in the image (SMA Ours in FIG. 7) generated using the data augmentation method according to an embodiment of the present disclosure than the existing data augmentation method.

FIG. 8 is a block diagram illustrating a computing environment 10 including a computing device suitable for use in embodiments of the present disclosure. In the illustrated embodiment, respective components may have different functions and capabilities other than those described below, and include additional components in addition to those described below.

The illustrated computing environment 10 includes a computing device 12. In an embodiment, the computing device 12 may be the data augmentation device D. That is, the data augmentation device D may be implemented as the computing environment 10 as illustrated in FIG. 8.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

Therefore, the present disclosure performs data augmentation based on separation of object features and background features in a case of weakly supervised semantic segmentation to reduce the influence of background bias on a category classification model, and has the effect of quantitatively measuring the degree of background bias through an evaluation index.

Although representative embodiments of the present disclosure have been described in detail above, those skilled in the art will understand that various modifications may be made to the above-described embodiments without departing from the scope of the present disclosure. Therefore, the scope of the present disclosure should not be limited to the described embodiments, but should be defined not only by the patent claims described below but also by those equivalent to the patent claims.

What is claimed is:

1. A data augmentation method performed on a computing device that includes one or more processors and a memory storing one or more programs executed by the one or more processors, the method comprising:
inputting multiple images constituting a mini-batch into an encoder and extracting features for respective images of the multiple images;
inputting the extracted features of the respective images into a pre-trained first aggregator and second aggregator and separating the extracted features into object features, each being a feature of an object portion of each image, and background features, each being a feature of a background portion of each image;
inputting the object feature and background feature of each of the images into a shuffler and shuffling either the object features or the background features within the mini-batch;
generating a synthetic feature by synthesizing the shuffled feature and a non-shuffled feature among the object feature and the background feature in a synthesis unit; and
generating a data-augmented image based on the synthetic feature.

2. The data augmentation method of claim 1, further comprising:
training the first aggregator and the second aggregator,
wherein the training includes:
inputting an image to an encoder to extract features for the image;
inputting the features for the image to the first aggregator to aggregate object features from the features for the image and inputting the features for the image to the second aggregator to aggregate background features from the features for the image; and
performing contrastive learning on the first aggregator and the second aggregator so that a similarity between the object feature and the background feature is reduced.

3. The data augmentation method of claim 1, wherein the shuffling includes shuffling the background features within the mini-batch, and
in the generating of the synthetic feature, the synthetic feature is generated by synthesizing the shuffled background feature with the object feature.

4. The data augmentation method of claim 1, wherein the shuffling includes shuffling the object features within the mini-batch, and
in the generating of the synthetic feature, the synthetic feature is generated by synthesizing the shuffled object feature with the background feature.

5. The data augmentation method of claim 1, further comprising:
measuring an activation value for object inference for each pixel in the data-augmented image; and
calculating a degree of background bias in the data-augmented image based on the measured activation value.

6. The data augmentation method of claim 5, wherein the calculating of the degree of background bias includes:
measuring each of a contribution rate of the object portion and a contribution rate of the background portion in the data-augmented image; and
calculating the degree of background bias based on a ratio of the contribution rate of the object portion and the contribution rate of the background portion.

7. The data augmentation method of claim 6, wherein the contribution rate of the object portion and the contribution rate of the background portion is measured by an integrated gradient of each pixel in the data-augmented image.

8. The data augmentation method of claim 7, wherein the integrated gradient of the pixel is calculated by Equation:
$$I ( {x}_{i} ) = ( {x}_{i} - {x}_{base} ) \cdot {\sum }_{k = 1}^{m} \frac{\partial f ( {x}_{base} + \frac{k}{m} ( {x}_{i} - {x}_{base} ) )}{\partial {x}_{i}} \cdot \frac{1}{m} \qquad [ Equation ]$$
$$where , I ( {x}_{i} ) : integrated gradient of i - th pixel in data - augmented image$$
$${x}_{i} : data - augmented image$$
$${x}_{base} : preset black image$$
$$m : number of gradients$$
$$k : k - th gradient$$
$$\frac{\partial f ( \cdot )}{\partial {x}_{i}} : degree to which i - th pixel in augmented image contributes to classifier ’ s output class score .$$

9. The data augmentation method of claim 7, further comprising:
calculating an activation ratio value by a ratio of an integrated gradient of pixels in an object region and an integrated gradient of pixels in a background region in the data-augmented image.

10. A computing device comprising:
a processor; and
a memory storing one or more programs executed by the processor,
wherein the processor is configured to perform:
an operation of inputting multiple images constituting a mini-batch into an encoder and extracting features for respective images of the multiple images;
an operation of inputting the extracted features of the respective images into a pre-trained first aggregator and second aggregator and separating the extracted features into object features, each being a feature of an object portion of each image, and background features, each being a feature of a background portion of each image;
an operation of inputting the object feature and background feature of each of the images into a shuffler and shuffling either the object features or the background features within the mini-batch;
an operation of generating a synthetic feature by synthesizing the shuffled feature and a non-shuffled feature among the object feature and the background feature in a synthesis unit; and
an operation of generating a data-augmented image based on the synthetic feature.

11. A computer program stored on a non-transitory computer readable storage medium, the computer program including one or more instructions, the instructions, when executed by a computing device having one or more processors, causing the computing device to perform:
inputting multiple images constituting a mini-batch into an encoder and extracting features for respective images of the multiple images;
inputting the extracted features of the respective images into a pre-trained first aggregator and second aggregator and separating the extracted features into object features, each being a feature of an object portion of each image, and background features, each being a feature of a background portion of each image;
inputting the object feature and background feature of each of the images into a shuffler and shuffling either the object features or the background features within the mini-batch;
generating a synthetic feature by synthesizing the shuffled feature and a non-shuffled feature among the object feature and the background feature in a synthesis unit; and
generating a data-augmented image based on the synthetic feature.
